(19) United States
(12) Patent Application Publication
(10) Pub. No.: US 2016/0310343 A1
(43) Pub. Date: Oct. 27, 2016

(54) Cane Holder for a Walker

(71) Applicant: George Julos, Washington, PA (US)

(72) Inventor: George Julos, Washington, PA (US)

(21) Appl. No.: 15/133,579

(22) Filed: Apr. 20, 2016

Related U.S. Application Data
(60) Provisional application No. 62/152,188, filed on Apr. 24, 2015.

(51) Int. Cl. A61H 3/00

(52) U.S. Cl. CPC A61H 3/00; A61H 2003/002

(57) ABSTRACT

The invention is a cane holder disposed as an elongated body having a hollow cane receiving core, and having one or more through bores formed into a wall of the body with one or more access openings formed opposite the through bores into side wall. The through bores and enlarged openings are sized and spaced so as to match existing screw or other fastener holes formed in a frame of a walker. The access openings allow fasteners for the cane holder to be easily accessed and removably fastened or unfastened to the frame of the walker. An adaptor plate is also provided. A second embodiment uses a tube clasp in lieu of the fastener-hole system and is pressure fitted directly onto a tubular frame of the walker.

### CROSS REFERENCE TO RELATED APPLICATIONS

Reference is made to and priority claimed from U.S. provisional application Ser. No. 62/152,188 filed 24 Apr. 2015.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE OF MATERIAL SUBMITTED ON A COMPACT DISC OR AS A TEXT FILE VIA THE EFS WEB SYSTEM

Not applicable.

### STATEMENT REGARDING PRIOR DISCLOSURES BY THE INVENTOR OR A JOINT INVENTOR

Not applicable.

### BACKGROUND OF THE INVENTION

(1) FIELD OF THE INVENTION

The present invention pertains to the field of walking assistance apparatuses. More particularly, the present invention pertains to a walking cane holder affixed to a walker such that a user can securely store a walking cane in the holder while using the walker, and easily remove the walking cane as desired.

(2) BACKGROUND ART

The present invention relates to walking assistance apparatuses, specifically walkers and walking canes used by individuals who are capable of walking, but need some help with balance or steadiness. Many individuals use both walkers and canes, but standard walkers are not designed to hold canes, and safe, convenient storage of the cane on the walker frame itself poses many problems. Many try hooking the curved handle of the cane over an armrest of the walker, but the cane is not secure, and tends to swing and fall off as the walker is moved forward, creating a tripping hazard for the user. Some attempt to hold the cane while simultaneously gripping the walker handles, but this is an unsatisfactory solution for those with small hand size, or weakened hand strength. Snap on holders which are pressure mounted to the frame of the walker and which require the walking cane to be pushed into the holder for storage and pulled out for removal, are also highly unsatisfactory since the very act of pushing and pulling to store or remove the cane is often a two-handed operation, requiring both strength and balance, two things often lacking in individuals who need walking aids in the first place.

What is needed is a convenient, safe, and easy to use cane holder that securely holds a stored cane to a walker frame, and which allows the user easy one-handed removal and storage of the cane, as desired.

### (3) BRIEF SUMMARY OF THE INVENTION

The invention is a walking cane holder for use with a walker having a tubular frame, the cane holder featuring a cylindrical body having a side wall defining a cane receiving hollow core and a pair of parallel openings formed on opposed sides of the side wall, a first opening being a through bore sized and shaped to receive a fastener and a second opening being an access opening allowing a fastener tool to be inserted so as to allow the through bore to receive a fastener. The size and spacing of the through bores are a same size and spacing as a set of existing holes formed into the tubular frame of the walker.

In another aspect of the invention, an adaptor plate is included having an array of through holes with a plurality of sizes and spacings, the array of through holes corresponding with existing holes in one or more walkers.

In yet another aspect of the invention, the cane holder is disposed as an elongated body having a cane receiving hollow core and a c-shaped tube clasp formed adjacent the hollow core, the tube clasp sized and shaped to pressure fit onto the frame of the walker.

### (4) BRIEF DESCRIPTION OF THE DRAWINGS

The features and advantages of the invention will become apparent from a consideration of the subsequent detailed description presented in connection with accompanying drawings, in which:

FIG. 1 is a front elevational view of a first embodiment of a cane holder according to the invention.

FIG. 2 is a perspective view of the cane holder in FIG. 1, shown affixed to a walker and holding a cane.

FIG. 3 is a cross sectional side view of the cane holder in FIGS. 1 and 2.

FIG. 4 is a front elevational view of an adaptor plate according to the invention.

FIGS. 5A-B are a top elevational views of a second embodiment of a cane holder according to the invention.

### (5) DRAWINGS LIST OF REFERENCE NUMERALS

10 side wall of holder body
12 hollow core (cane receiving member)
14 through bore
16 access opening
18 fastener
20 walker
22 tubular frame of walker or walker frame or frame
30 walking cane or cane
40 adaptor plate
50 cane holder or walking cane holder
514 tube clasp

### (6) DETAILED DESCRIPTION

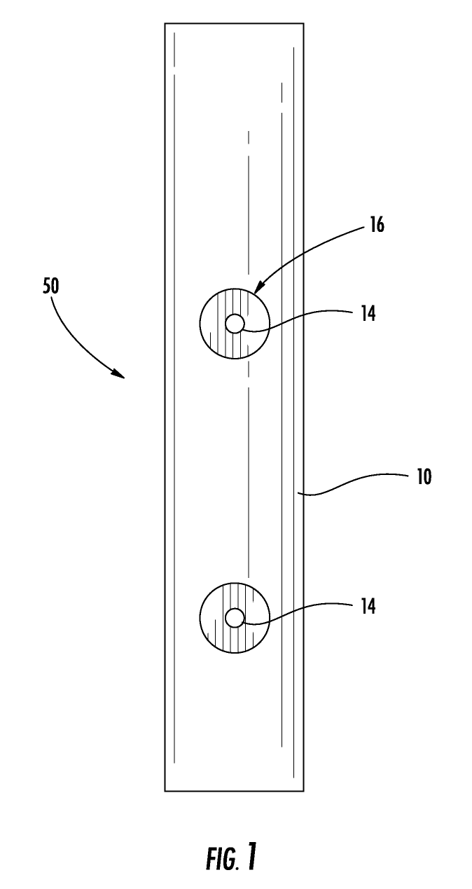

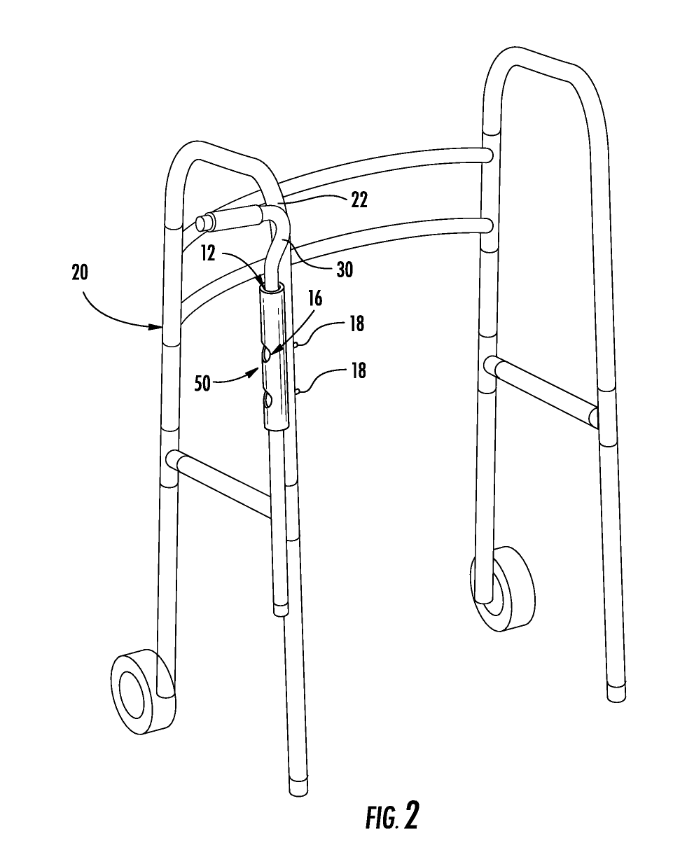

A cane holder 50 according to the invention is shown in FIGS. 1-5B. The cane holder in a first embodiment is disposed as a cylindrical body having a side wall 10 with a cane receiving hollow core 12, and having one or more through bores 14 formed into the side wall 10 of the cylindrical body and one or more opposed access openings 16. The through bores 14 and access openings 16 are sized and spaced so as to match existing fastener holes (not shown) formed in a tubular frame 22 of a walker 20. The access openings 16 allow a fastening 18 for the cane holder 50 to be easily accessed and allow the cane holder to be removably fastened or unfastened to the frame 22, as needed. It should be noted that a size of the access openings 16, as shown in the Figures, is illustrative only and can vary from generously sized, to allow ample access to the fastener holes and weight or material reduction of the cane holder 50, as well as sized sufficiently large enough to allow access to the fastener holes, for instance, sizing the access openings 16 so as to conform with a diameter of a screwdriver tip, typically 0.25 inches wide. The cane holder 50 is positioned so as to line up at least one existing fastener hole in the frame 22 of the walker 20 with the through bore 14 of the cane holder 50, and a fastener 18, typically a screw or threaded bolt defined by a head and a threaded body, is inserted into the through bore 14 via the access opening 16. In the embodiment shown in the Figures, the existing fastener hole in the frame 22 is an upper hole, and a lower fastener hole in the frame 22 has been created by the inventor by drilling into the frame 22.

Suitable walkers for use with the cane holder 50 include those made by Invacare Corporation of Elyria, Ohio, and commonly provided via Medicare. Also compatible with the invention is a walker made by Drive Medical of Fort Washington, N.Y., commonly provided to veterans via the U.S. Department of Veteran's Affairs. The inventor notes that for a walker sold by Drive Medical, the lower fastener hole must also be drilled into the walker frame 22. For other embodiments, both holes are pre-existing fastener holes in the frame 22. Existing fasteners used to hold the frame 22 together may be reused, since the cane holder wall is relatively thin, however the inventor, in a typical embodiment, envisions replacing existing fasteners with appropriately-sized fastener 18.

A representative first embodiment of the cane holder 50 shown in FIGS. 1-4 has a cylindrical body typically 12 inches long and one and a half inches in diameter. The access openings 16 range from a quarter inch to one and a half inches in diameter, each access opening having the through bore 14 formed in the side wall 10 and centered in the access opening 16. The spacing between through bores and access openings typically correspond to existing fastener holes in the walker frame 22.

Once the cane holder 50 is fastened securely to the frame 22, a walking cane 30 is inserted through the top and housed in the cavity of the cylindrical body. The cylindrical body prevents the cane 30 from swinging or falling off the walker 20 as the walker 20 is moved, either by pushing or repetitive lifting and placing the walker 20 in a forward direction. Walkers typically have a variety of locations on their frames that can accommodate the cane holder 50 and the user can thus affix the cane holder 50 in a preferred location along the frame 22. The location suggested by the inventor in the Figures is convenient to the inventor himself, but he also acknowledges that the cane holder 50 can be affixed to other parts of the walker frame as desired.

The inventor also notes that there are many walker manufacturers, so the through bore 14 and access opening positions 16 are adjustable and can be adapted to be affixed to an adaptor plate 40, as shown in FIG. 4, the adaptor plate 40 having a plurality of through bores 14 sized and positioned to accommodate differences in most major walker brands, and a second set of fasteners 18 is included for affixing the adaptor plate 40 to the frame 22, and the existing set of fasteners 18 used for affixing the cane holder 50 to the adaptor plate, via the access openings 16. It is also possible to use just a single set of fasteners 18 to fasten the cane holder 50 and adaptor plate 40 directly to the frame 22.

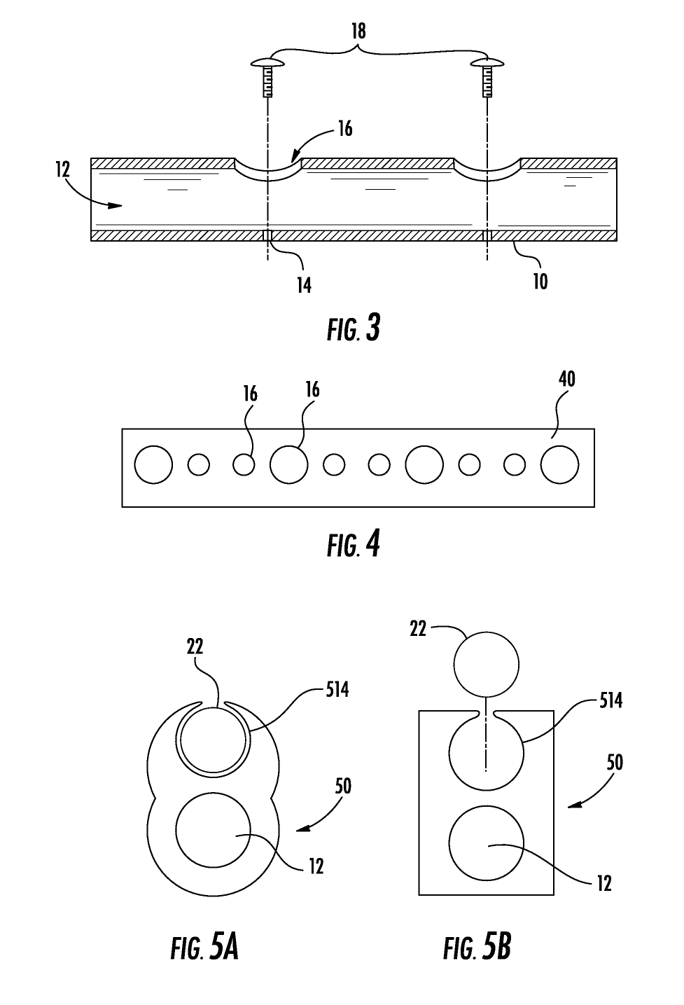

A second embodiment of the cane holder 50 is shown in FIGS. 5A-B. A pair of through bores are formed in a body of material, typically comprised of plastic, PVC, aluminum, or other suitable material that is capable of being bored or drilled, a first through bore being a hollow core 12 formed along an entire length of the body and sized and shaped to receive the walking cane 30, and a second through bore being a tube clasp 514 parallel and adjacent to the hollow core 12, the tube clasp 514 sized and shaped to receive the tubular frame 22 of the walker 20. It should be noted that the frame 22 here defines an area below an uppermost horizontal hand grasp of the walker and a lowermost horizontal member of the walker, although as stated previously, the cane holder 50 can be fitted to any other suitable tubular frame portion of the walker. Pressure fitting the cane holder 50 shown in FIGS. 5A-B to the frame 22 ensures the cane holder 50 remains positioned in a convenient location on the walker 20 near the uppermost horizontal hand grasp. The tube clasp 514 is c-shaped, so as to be capable of receiving the frame 22 by forcing the opening of the tube clasp 514 against the vertical member and deforming the c-shaped opening so as to pressure fit the frame 22 into the tube clasp 514. Removal of the tube clasp 514 from the frame 22 is achieved by pulling the cane holder 50 horizontally away from the frame 22, causing the tube clasp 514 to deform slightly so as to release the frame 22.

In FIG. 5A, a top view of the cane holder 50 has a cross section resembling a figure eight, with a missing segment about a perimeter of the cane holder defining the c-shaped opening of the tube clasp 514. In FIG. 5B, a top view of the cane holder 50 has a rectangular cross section, with the hollow core 12 and tube clasp 514 formed into the body, and differing only in an exterior shape with FIG. 5A, where the embodiment shown in FIG. 5A has a curved exterior shape, and in FIG. 5B has a rectangular exterior shape. The exterior shape does not affect the function of the cane holder 50 according to the invention, but rather is selected according to aesthetics, manufacturing, or other reasons unrelated to functionality. The second embodiment is removably affixed to the walker 20, and can be conveniently and quickly removed without tools.

The inventor notes that the cane holder 50 shown in FIGS. 5A-B can be made by either boring into a solid material, such as a PVC rectangular rod, to remove material and thus shape the cane holder, or alternatively, shaped using extrusion, injection molding, or other suitable manufacturing methods. The inventor notes that the body of the cane holder 50 in the second embodiment is also disposed as an elongated body. The elongated shape of the cane receiving means 12 ensure that the walking cane 30 does not swing back and forth when stored in the cane holder and thus maximize safety. The elongated body is of a length ranging from at least 2 inches to about 12 inches long, as desired.

It is to be understood that the above-described arrangements are only illustrative of the application of the principles of the present invention. Numerous modifications and alternative arrangements may be devised by those skilled in the art without departing from the scope of the present invention.

What is claimed is:

1. A walking cane holder (50) for use with a walker (20) having a frame (22) and for holding a walking cane (30), the cane holder comprising:
a side wall (10) defining a hollow core (12),
a through bore (14) of a predetermined size formed into the side wall (10); and
an access opening (16) of a predetermined size formed into the side wall (10) opposite the through bore (14);
wherein the hollow core (12) is sized and shaped to receive the walking cane (30);
wherein the walking cane holder (50) is affixed to the walker (20) by a fastener (18); and
wherein the predetermined size of the access opening (16) is greater than the predetermined size of the through bore (14).

2. The cane holder (50) of claim 1, further comprising a second through bore (14) and a second access opening (16), wherein the second through bore (14) and the second access opening (16) are in a predetermined spaced apart relationship with the through bore (14) and the access opening (16).

3. The cane holder (50) of claim 1, wherein the predetermined size of the access opening (16) is no greater than 0.25 inches in diameter.

4. The cane holder (50) of claim 1, further comprising an adaptor plate (40), the adaptor plate having two or more through bores (14) in spaced apart relationship.

5. The adaptor plate (40) of claim 4, wherein the two or more through bores (14) in spaced apart relationship correspond to a same spaced apart relationship of two or more preexisting through bores formed into the frame (22).

6. The cane holder (50) of claim 4, further comprising a second set of fasteners (18), the two or more through bores (14) of the adaptor plate (40) adapted to receive the second set of fasteners (18).

7. The cane holder (50) of claim 6, wherein the second set of fasteners (18) are a same set of preexisting fasteners (18) of the walker (20).

8. A cane holder (50) for holding a walking cane (30) and for attachment to a walker (20) having a tubular frame (22), the cane holder (50) comprising:
a cane receiving means (12); and
a tube clasp (514);
wherein the tube clasp is sized and shaped to receive the tubular frame (22) of the walker (20).

9. The cane holder (50) in claim 8, wherein the tube clasp (512) is made of plastic.

10. The cane holder (50) in claim 8, wherein the tube clasp is c-shaped.

11. The cane holder (50) in claim 8, wherein the cane receiving means (12) is made of plastic.

12. The cane holder (50) in claim 8, wherein the cane receiving means (12) is disposed as an elongated body at least two inches long.
